(19) United States
(12) Patent Application Publication
(10) Pub. No.: US 2026/0253145 A1
(43) Pub. Date: Aug. 27, 2026

(54) Methods and Apparatus for Automating Real Property Documentation, Inventory Record Keeping and Insurance Policy Record Keeping

(71) Applicant: GBL SYSTEMS CORPORATION, Camarillo, CA (US)

(72) Inventors: James Buscemi, Camarillo, CA (US); Jason Laver, Thousand Oaks, CA (US)

(21) Appl. No.: 19/534,750

(22) Filed: Feb. 9, 2026

Related U.S. Application Data
(60) Provisional application No. 63/756,044, filed on Feb. 7, 2025.

(51) Int. Cl. G06Q 40/08; G06Q 10/087

(52) U.S. Cl. CPC G06Q 40/0841; G06Q 10/08774; G06Q 40/08222

(57) ABSTRACT

Method and apparatus for documenting a building and its contents are described based on photographs and for automatically generating and submitting an insurance claim are described. AI systems are used to automatically identify objects which are listed in pre-damage and post damage lists.

### RELATED APPLICATIONS

The present application claims the benefit of U.S. Provisional patent application 63/756,044 filed Feb. 7, 2025 which is hereby expressly incorporated by reference in its entirety.

### FIELD

The present application relates to automating documentation of real property and the inventory relating to a real property as well as insurance policy record keeping and/or interpretation and for automated determinations of actual loss following a fire or other incident to allow for efficient automated generation and accurate documentation and processing of claims.

### BACKGROUND

Fires, especially wild fires can be unpredictable and sudden. Home fire loss can be sudden and completely unexpected which is often the case due to fires caused by electrical faults or mechanical system failures. In other cases fire loss can be due to wildfires with some small warning being provided in some cases to a home owner in which to evacuate. Whether a fire is completely unexpected or preceded by a small warning period allowing a homeowner to evacuate before a wild fire reaches their house, by the time the homeowner becomes aware of an actual fire threatening their house there is normally insufficient time to from the point of concern about an actual fire to the time of evacuation for the homeowner to document a houses contents.

Once a fire occurs a homeowner is not only confronted with the problem of how to document and determine the contents of a house for insurance claim purposes, the homeowner is often confronted with the difficulty of interpreting an insurance policy to determine what portion of a loss might be covered and/or whether there are coverage exemptions which might apply given their particular insurance policy and/or the cause or type of fire for which loss coverage is being sought.

A home owner confronted with a loss due to a fire, to obtain a fair settlement with regard to insurance coverage is confronted with the problem of documenting the loss due to the fire. Often the loss in terms of building damage is so severe that it is impossible to determine from the burnt remains the contents of a building with any great detail. For example, it may be impossible to determine the number of bookcases or chairs that were in a room or office of a home, the number of pencils on a desk or the number of framed pictures or framed pieces of art on a wall.

What countertop appliances, e.g., blenders, coffee makers and/or food processors in a kitchen might be difficult to determine or document from the burnt remains of a home. Similarly, what living room furniture and/or the brand of furniture might not be clear from the burnt remains.

Thus, it should be appreciated that while the overall size and number of rooms of a burnt house may be determinable after a fire from the remains and/or building records, the content of the burnt buildings may be difficult to document in support of an insurance claim.

How to record and document the content of a property in sufficient detail to be able to determine the scope of a loss due to a fire or other event, e.g., natural disaster in a way that the record will survive the disaster is a technical problem. In addition to the problem of how to create and store records that can be used in the event of a loss, there is also a need for a way to determine in a verifiable way the scope of the loss after an event in a way that can hopefully be automated. Once the content of a property, e.g., home premises that was partially or fully destroyed and scope/contents that were destroyed determined, it would be desirable if there was a away to automatically generate and submit an insurance claim on behalf of the owner of the property or insured entity affected by the loss. Generation of a claim and submission can involve collecting and processing various information and then submitting it, e.g., via a communications network to an insurance provider's system.

How to automate and reliably perform various aspects relating to documenting a property, storing records relating to the property, determining the scope of a loss due to an event such as a fire, and generating a claim are technical problems which need to be addressed.

While various artificial intelligence systems are available for public use in providing information on insurance policies and/or grouping photos, such systems often provide inaccurate or unreliable results. Many individuals do not know what to do and/or what to believe when different AI systems provide differing results and therefore may avoid using or relying on such systems for important matters such as determining what insurance claim or claims can be made in the event or loss and/or in documenting or supporting an insurance claim.

In view of the above, it should be appreciated that there is a need for automated methods and/or apparatus which could be used to an individual to perform one or more of the following: document and catalog the contents of a property, store information regarding the contents of a property, determine the scope of a loss including the items destroyed, generate a list of destroyed items, automatically generate an electronic claim for the determined loss and communicate the electronic claim over a network to a system for processing.

### SUMMARY

Methods and apparatus for technically automating all or portions of the processes of documenting, supporting and/or making an insurance claim due to a loss due to a fire or other loss event are described.

In various embodiments photographs of a building structure, e.g., home or customer premises are collected. For purposes of explaining the invention the building structure will be referred to in various locations as a home but it could be any of a variety of buildings including commercial buildings. Images of the rooms inside the home are captured stored and processed. One or more AI systems are used to analyze the contents of the images of the rooms and catalog the items in the rooms. A user can and sometimes does supplement the automatically generated inventories of rooms based on user knowledge and/or evidence of the manufacturer or brand of items in the room which can be from purchase information and/or receipts. Electronic copies of the receipts for items in rooms can be and sometimes are stored in association with images of the room contents and the automatically generated and optionally user supplemented, list of room contents. The digital images corresponding to a home and the contents of the rooms in the home along with the receipts and other information corresponding to the items known to be in the home are stored at one or more locations which are physically and distant from the home, e.g., at a server provider system such as a server or cloud based system, located miles or even hundreds of miles from the home or home to which the stored information relates.

In various embodiments, in the event of a fire or other loss, pictures of the affected buildings are captured. A picture of a destroyed or damaged structure, e.g., home, is compared to one or more pre-loss images of the damaged or destroyed structure. For each structure for which damage/loss analysis is performed, the extent of the damage to the home is determined, rooms which were destroyed due to damage identified and the contents of the rooms that were destroyed determined from the stored information. An itemized list of destroyed items corresponding to a home is generated in some embodiments. An estimate of the value of the destroyed items can be and sometimes is generated by consulting one or more publicly available AI systems to provide estimates of the cost of the destroyed items. Based on the automatically generated list of destroyed items and/or information about the damage that occurred to the building, e.g., home, an insurance claim is generated in some embodiments and communicated to an insurance company claims processing system. The claim can be and sometimes is transmitted with digital images and/or other information supporting the inventory of items described, the extent of building damage and/or other information such as purchase receipts corresponding to items that were destroyed. The communication of images, claim and other supporting information in digital form can be and often is sent to the insurance company claims processing system via a communications network, e.g., from a service provider system with access to the stored images corresponding to the building and rooms to which the insurance claims relate.

Since the storage location of the information and data needed to support the claim are stored at one or more locations far away from the insured building, e.g., home, the digital information remains intact and available to the homeowner even when the home to which the information relates is completely destroyed. Furthermore, by allowing a user to capture images and interact with the documentation/inventory system via a cell phone or other user device, an individual who's home or property is destroyed can still easily generate the necessary documentation, inventory and claim and have it delivered electronically despite having their home destroyed.

While it is preferable that an inventory of a home is generated and stored prior to a loss, in various embodiments the same techniques used for generating a home inventory can and sometimes are used after a loss to document pre-loss contents of a home and a list of destroyed items but in such a case the item list is generated after the loss from images of rooms and/or the damaged structure which were taken prior to the loss and in many cases a comparison to one or more images of the structure after the loss.

By automating item documentation and generation of per room inventories based on images, disputes as to the contents rooms, items destroyed in a fire, and the value of such items can be reduced or avoided as compared to cases where automation and analysis, e.g., AI analysis, of images are not used to generate and document the contents of a home or other structure.

Various features take advantage of modern AI systems to interpret documents including insurance policies. Other features take advantage of the ability of AI and/or image recognition systems to identify different images corresponding to the same room or building and identify objects in an image. Sill other features relate to automatic generation of list of items shown in images and/or know to be in a room, provide information relating to identified items, e.g., brand and cost of the identified item, and/or to create an overall inventory of items in a structure or room.

Various features of the present invention take advantage of publicly available AI systems to process information and/or images provided by a user of the system of the present invention. A user is presented with prompts to provide information and/or images relevant to their objective, e.g., understanding an insurance policy, putting together documentation for a claim and/or simply creating a record to support a future claim in the event of an insurance loss covered by an insurance policy.

In various embodiments, the system automatically responds to user input, e.g., response to prompts, by making a call to an AI system. The results to the query are then processed and either presented to the user and/or used in creating lists and/or other documentation to support an insurance claim for a loss.

In some embodiments, the system calls multiple different AI systems, e.g., first and second AI systems, and considers whether the results, e.g., policy limits and/or exclusion information returned by the different systems match. If the results match, the information is provided to the user. If there is a difference in the returned results, e.g., different systems return different policy limits or different amounts of coverage, the results from a second AI system are provided as input to first AI system with a query as to why the results returned from the first AI system differ or might be different from the expected result which was the result from the second AI system. In such a case the results of the two AI systems and the indicated reason they might differ are presented to a user of the system. In this way, where there is a discrepancy between outputs of different AI systems not only is the user made aware of the different answers but is presented with possible reasons for the difference in answers. This can be extremely helpful to a user seeking to interpret his/her insurance policy and avoids the need for the user to understand how to query AI systems and/or how to try to understand what might be the reason for the differences in interpretations of their insurance contract.

While AI systems can be used to facilitate an understanding of an insurance policy's limits and/or exclusions, the generation, storage and remote accessibility of documentation to support an insurance claim in the event of loss can be even more important and significant to an individual since without such documentation a user may not be able so successful make a claim for a loss.

In various embodiments in order to support a provide documentation to support a claim for a loss, e.g., due to a fire in which a home, office or other building burnt down or as preparation for a potential loss, a user submits one or more photographs of a building and/or the rooms of the building.

In some embodiments the photographs are submitted to an AI system or image recognition system which is asked to group photos corresponding to the outside of the building and photos corresponding to individual rooms together. For example, the AI system may be asked to identify images corresponding to a kitchen into one group, photos corresponding to individual bedrooms into another group and photographs corresponding to offices in another group.

The user of the system can then review the photographs and indicate the room or rooms each photograph corresponds to.

The photographs corresponding to a room are submitted to an AI system for analysis. The AI system recognizes furniture, appliances and other objects in each room and creates an itemized list of items corresponding to the room. The AI system is asked to identify the manufacturer and/or model of each item if possible. In addition the AI system is asked to provide information on the cost of each item.

A user is presented the list of items corresponding to a room and provided an opportunity to update the list with manufacturer, model and/or cost information. The user is also provided an opportunity to add and/or identify items which were not automatically identified from pictures of the room to form a complete inventory along with price information for items added to the list if available.

The AI system is asked to update the list with cost and/or other information for items added to the list or for which the user provided supplemental information.

Through the use of the AI System(s) and user input, a list of furniture, appliances and other items, along with the quantity and cost of each item in each room is generated. The AI system can and sometimes does provide information supporting the cost estimate of each item. A user can associate other information such as purchase receipts for furniture items or art work with the inventory list corresponding to a room to further support a claim.

Once an itemized inventory is generated for each room of the building to which a claim relates along with corresponding cost information, the user is provided an opportunity to automatically submit a claim for loss. If the user indicates a desire to submit a claim for loss, the user is provided the opportunity to upload pictures of the loss, e.g., burnt building and/or building remains. Photos documenting the loss along with the per room inventory and cost estimates of listed items is submitted to an insurance system for processing.

While explained largely using examples of inventorying rooms of a house or building, in some embodiments items outside the home on a property can be and are inventoried based on photos along with documentation of external building features and/or outdoor furniture. Such items can be and sometimes are automatically itemized and included in a submitted claim for loss.

The automatic inventory generation of items based on images using one or more AI systems to recognize and count objects in the images is not limited to documenting the contents for a home but can be and sometimes are used for generating lists of items donated to charities from images of donated goods and/or generating lists of items, with or without supplementary information and/or documentation provided by a user of the system with the list being generated from one or more images and consultation with one or more AI systems to which the images are provided.

Numerous variations are possible with many features and embodiments being described or apparent from the detailed description which follows.

### BRIEF DESCRIPTION OF THE FIGURES

FIG. 1 is a diagram showing an exemplary system implementing an exemplary embodiment of the present invention.

FIG. 2A is a first part of a flow chart showing steps of a method implemented in accordance with an exemplary embodiment which can be implemented by the system shown in FIG. 1.

FIG. 2B is a second part of a flow chart showing steps of a method implemented in accordance with an exemplary embodiment which can be implemented by the system shown in FIG. 1.

FIG. 2C is a third part of a flow chart showing steps of a method implemented in accordance with an exemplary embodiment which can be implemented by the system shown in FIG. 1.

FIG. 2D is a fourth part of a flow chart showing steps of a method implemented in accordance with an exemplary embodiment which can be implemented by the system shown in FIG. 1.

FIG. 2E is a fifth part of a flow chart showing steps of a method implemented in accordance with an exemplary embodiment which can be implemented by the system shown in FIG. 1.

FIG. 2F is a sixth part of a flow chart showing steps of a method implemented in accordance with an exemplary embodiment which can be implemented by the system shown in FIG. 1.

FIG. 2G is a seventh part of a flow chart showing steps of a method implemented in accordance with an exemplary embodiment which can be implemented by the system shown in FIG. 1.

FIG. 2H is an eight part of a flow chart showing steps of a method implemented in accordance with an exemplary embodiment which can be implemented by the system shown in FIG. 1.

FIG. 2 is a diagram showing how the steps shown in FIGS. 2A, 2B, 2C, 2D, 2E, 2F, 2G and 2H can be combined to form a complete flow chart showing the steps of an exemplary method implementing an embodiment of the invention.

### DETAILED DESCRIPTION

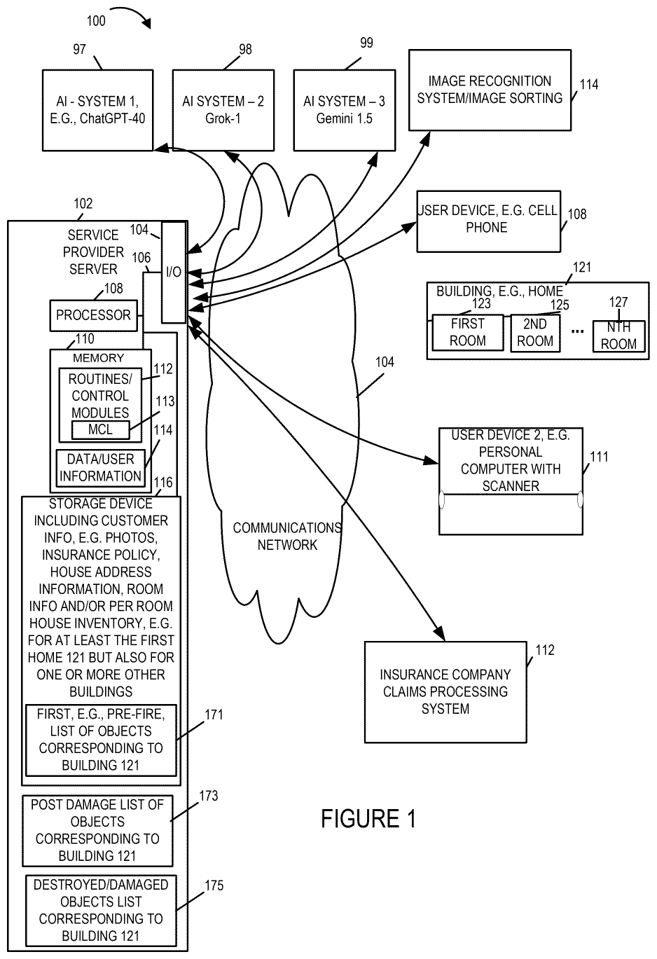

FIG. 1 is a diagram 100 showing a system implemented in accordance with one exemplary embodiment. They system includes multiple AI based systems 97, 98, 99 which are large language model (LLM) AI systems sometimes referred to a chatbots given their ability to respond to questions presented to them. Such systems are growing in popularity because they are normally trained on large data sets and can respond to a large range of questions based on information on which they are trained. Such information normally includes a wide range of information available on the Internet and/or from other data bases and can include information about products. In many cases the sales price of products is among the information on which such systems are trained since such information is often publicly available on the Internet. While AI systems can respond to questions, many such systems also have the ability to process photos, e.g., group photos based on their content and/or recognize items in photos. The ability of publicly available AI systems to respond to questions and process photos makes them powerful tools.

The FIG. 1 diagram includes a building, e.g., home 121 which includes multiple rooms, e.g., first room 123, second room 125 through Nth room 127. In various embodiments a user seeking to documents the building 121 and content of rooms 123, 125, 127 takes one or more pictures of the exterior of the building 121 and the content of the individual rooms 123, 125, 127. The images are used to generate an inventory of the objects in the rooms 123, 125, 127 as well as document the condition and features of the building. A first set of images digital or film images is captured corresponding to a first period of time, e.g., a period of time before a fire or other damage to the building and contents. A user can take the images using the cell phone 108 and obtain digital pictures that way. Alternatively the user capture pictures using a film camera and then scans printed copies of the images with the scanner 111 to create digital pictures. The digital pictures are stent to the service provider server 102 which then processes them to document the building 121 and its contents prior to damage.

A second set of images is captured after damage to the building 121, e.g., a fire. The second set of images which correspond to a later time period than said first set of images are communicated form the user device 108 or scanner 111 to the service provider server 102. The images from before and after the fire are analyzed by the service provider server 102 and/or one or more of the AI systems 97, 98, 99, 114 to identify damage to the building 121, which rooms were damaged, and to generate an inventory of the objects/items destroyed by the damage, e.g., fire. The list of damaged/destroyed objects in some embodiments is then used to automatically generate an insurance claim which is communicated to the insurance company claims processing system 112 via the communications network 104.

In some embodiments the service provider system 102 is located far away form the building 121 with the service provider system 102 storing images, lists of items and other information such as item purchase receipts, corresponding to the building 121 for which building/room inventories are generated and stored in the storage device 116. Given the physical distance between building 121 and server 102 the server is not likely to be damaged even when the building 121 is destroyed, e.g., by a wildfire.

In storage device 116 a pre-fire list of objects corresponding to building 121 is generated and stored. The pre-fire list may be and sometimes is a composite of individual lists of objects detected by one or more AI systems with a the composite list being formed by grouping together per room lists of objects, e.g., items such as a first list of items indicating items detected to be present in first room 123, a second list of items indicating items detected to be present in first room 125 and a third list of times detected to be present in Nth room 127.

The server 102 can be accessed and used via a customer's user device, e.g., cell phone 108 from any location where the cell phone can send or receive data. Accordingly, even if a user's home is destroyed in a fire the user can still access the data/information stored in server 102 and automatically generate an insurance claim with proof of loss and have it sent to the insurance company's claims processing system 112.

In the system 100, AI-systems 97, 98 and 99 are three different AI-systems which use different models to produce an answer to a question. The first AI system 1 97 uses a ChatGPT-40 model to produce answers, the second AI system 98 uses a Grok-1 model to produce answers and the third AI system 99 uses a Gemini 1.5 model to produce answers. The AI systems 97, 98, 99, in addition to using different models, in at least some embodiments, have been trained on different data sets. Accordingly, answers returned by the AI-systems 97, 98, 99 may differ even when asked the same questions and/or provided the same input. In addition to the LLM based AI systems 97, 98, 99 the system 100 also includes an image recognition system 114 which is a dedicated image recognition system trained to identify specific types of objects in images. Such a system 114, while being an AI system, may not use an LLM but instead be trained on images and use a model dedicated to image recognition applications. One or more of the AI image system 114 can be and sometimes is called when one of the other systems 97, 98, 99 has difficulty in identifying an object or objects in an image or to confirmation identifications made by the other systems 97, 98, 99. Any one or all of the AI systems 98, 98, 99 and 114 can be, and sometimes are called, e.g., used, to identify items included in images of rooms, exterior portions of a building and/or a yard. In accordance with the invention the recognized items can be and are used to create an inventory of items in a room or area and the price of such items can be determined, e.g., by the AI systems 97,98, 99 and/or based on user input such as a receipt or other user provided information. In various embodiments the AI system 97, 98, 99 and/or image recognition system 114 are used as interactive object recognition systems which identify objects in pictures, also sometimes referred to herein as images, sent to the systems 97, 98, 999, 114 for processing and which return lists of objects in the image(s) to the server 102 to allow the service provider server 102 to generate a list of items in the rooms of building 121 and the individual rooms 123, 125, 127 included therein.

In addition to the AI systems, the system 100 includes a service provider system 102 which corresponds to a provider of a service relating to inventory list generation, documentation of information to support an insurance claim and/or insurance claim submission. The service provider system 102 can and sometimes does provide a service by receiving information from a user, e.g., an operator of a cell phone 108 or other user device 111 which can contact the service provider system 102 when seeking advice on an insurance policy, to generate and store information which can be used to support a claim in the event of loss and/or to submit a claim to insurance company claims processing system 112.

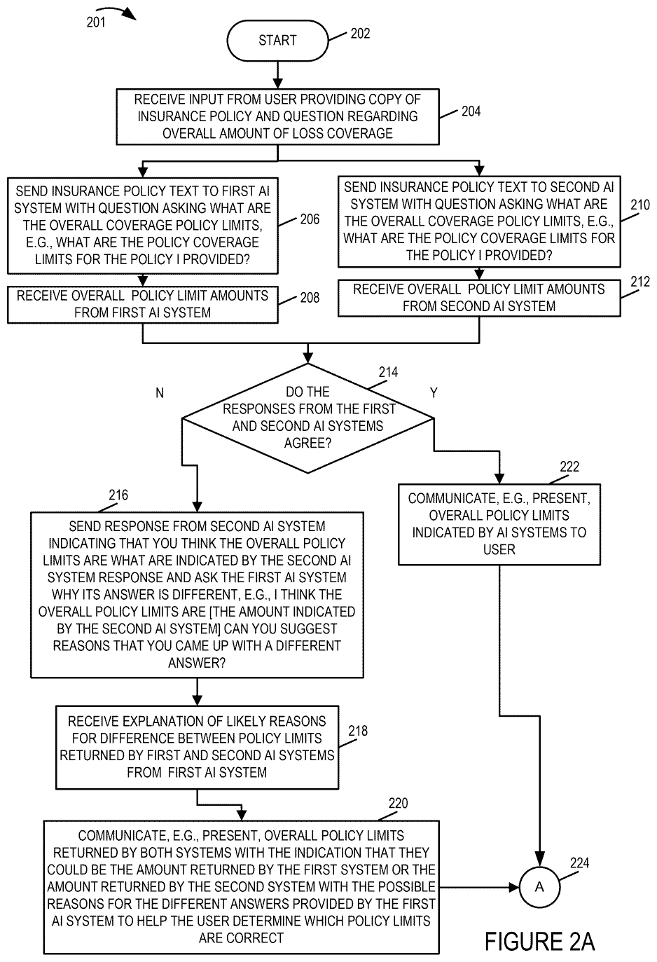

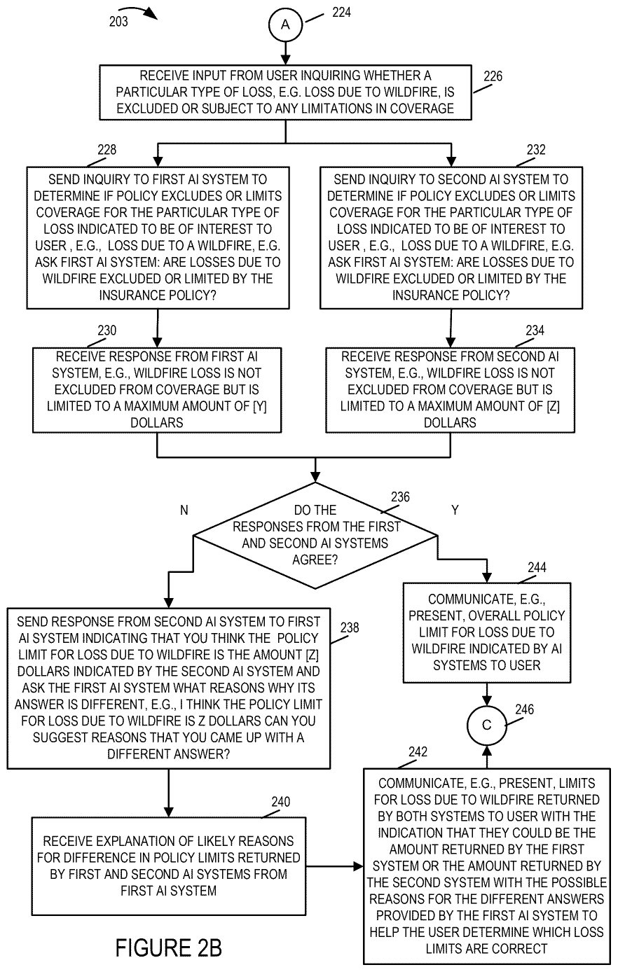

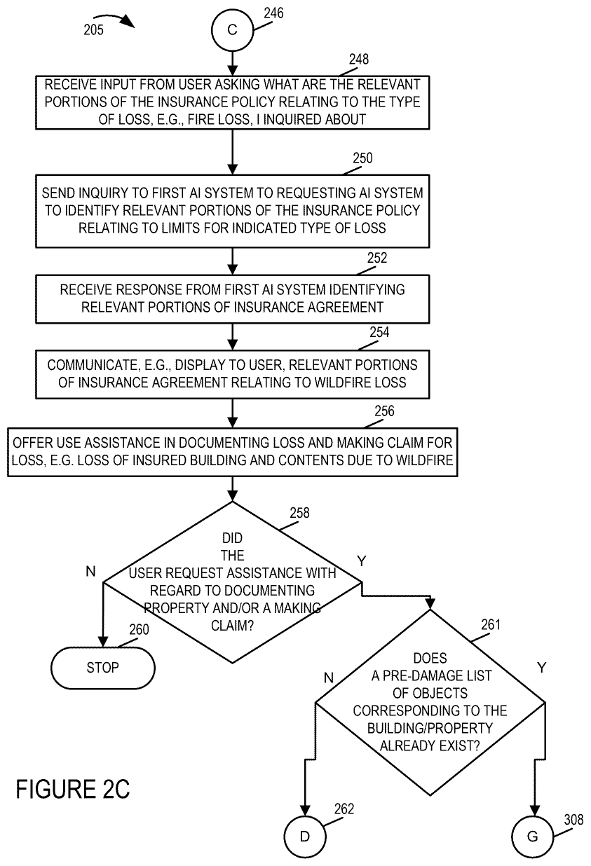

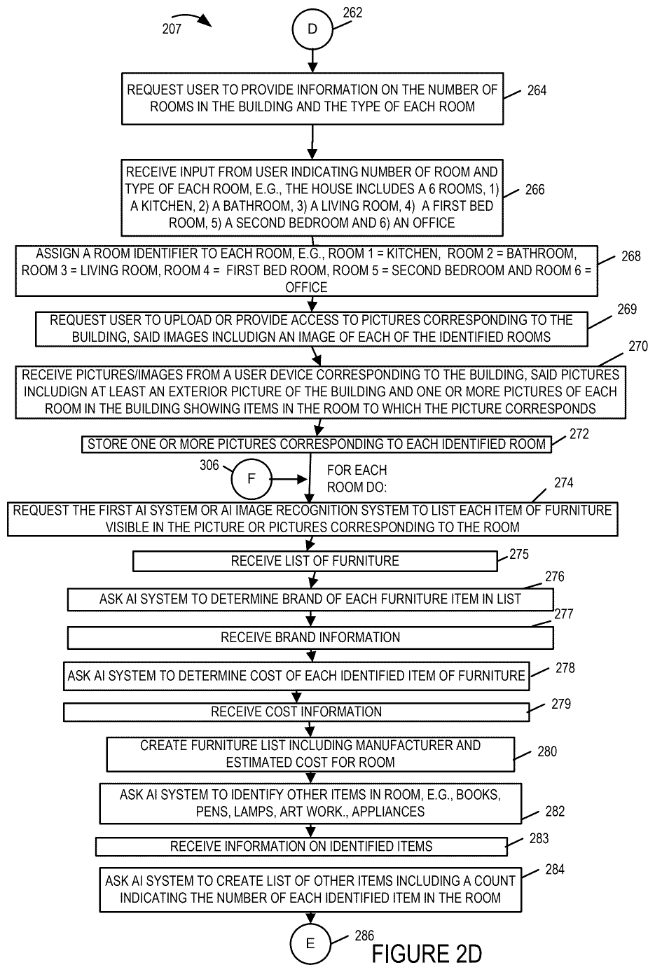

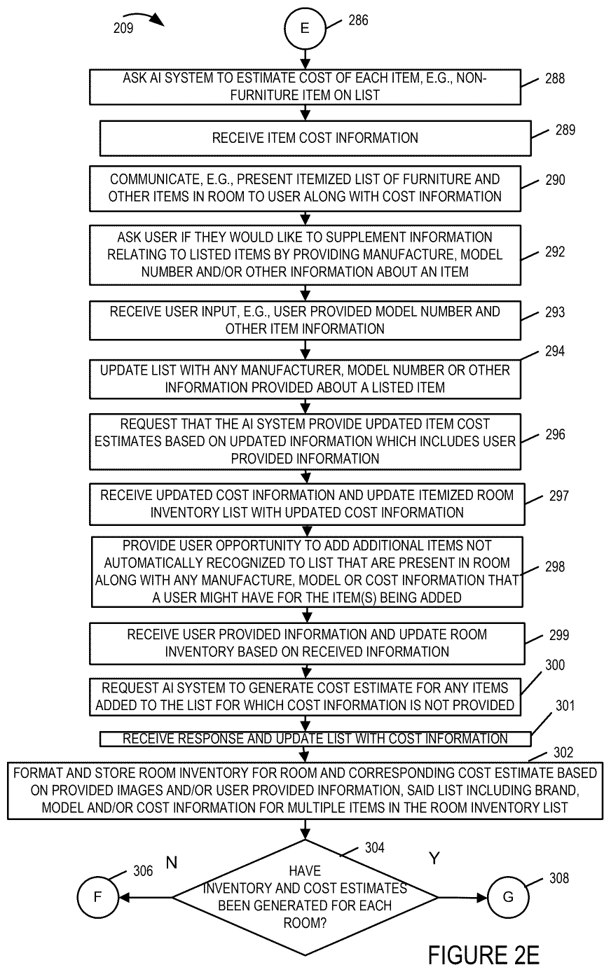

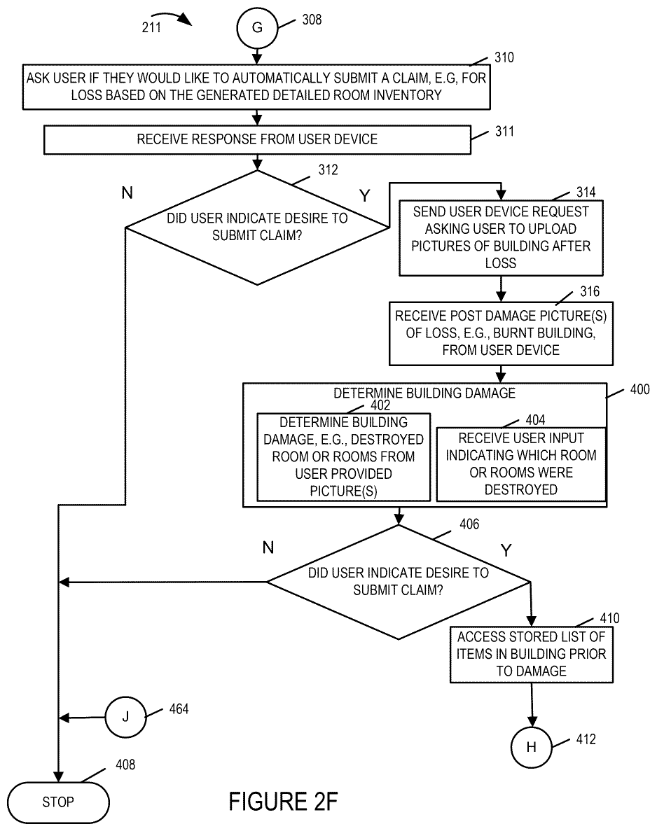

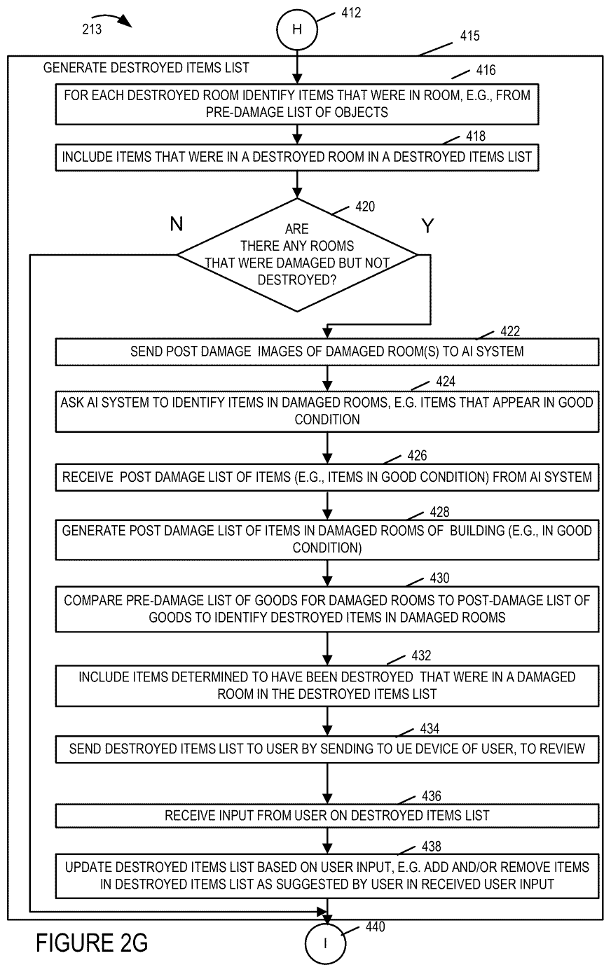

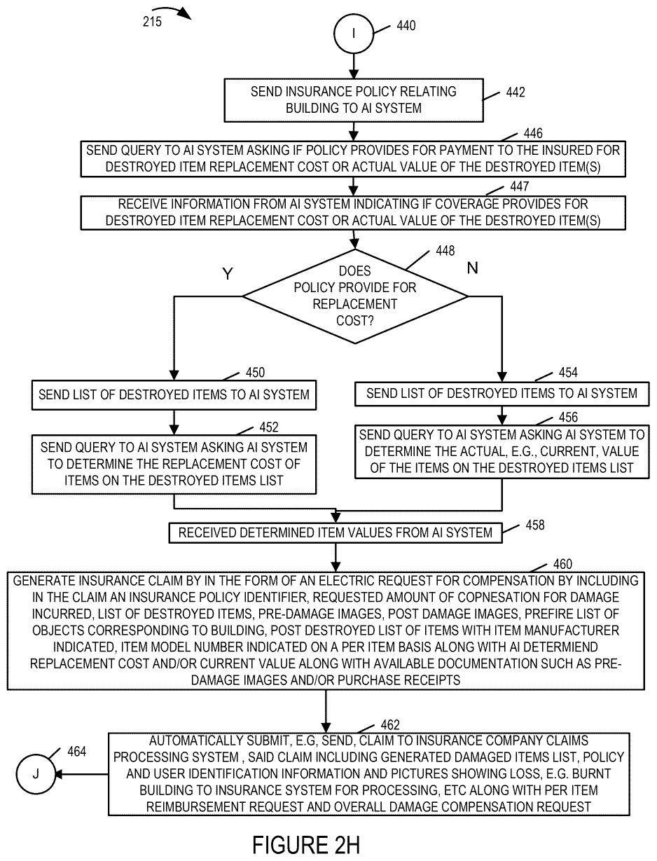

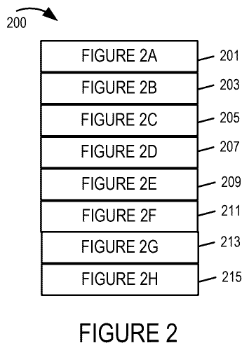

The service provider server 102 includes an input/output interface 104, processor 108, memory 110 and storage device 116, e.g., a hard disk drive. The memory 102 includes one or more routines and/or modules including a control routine which controls the service provider system to operated in accordance with the method shown in FIG. 2. The routines 112 include a main control routine (MCL) 113 which, when executed by processor 108, controls the service provider server 102 to perform the steps of the method shown in FIG. 2. In addition to the control routines 112, the memory 110 includes data and/or user information identifying users who can obtain service from the server 102 and the customer premises, e.g., buildings or homes, associated with users. While some data/user information is stored in memory 110, the storage device 116 can and sometimes does store customer information including photos, insurance policy information, room information, per room contents inventory information, building size information, etc. corresponding to individual users and their insurance policy. Storage device 116 is located at a location separate from the building/properties of the users, e.g., users of user device 108 and 111 so that in the event of loss the users can still access their insurance policy and have a documented record of building contents with photographic support in the event an insured property or building suffers a loss and the user's records, e.g., insurance policy, is destroyed in the loss. While storage device 116 can store records prior to a loss, it can also store records uploaded following a loss, e.g., to prepare a claim. In the case of records and photos uploaded following a loss, the records and photos may be obtained from the users cell phone 108 or another photo storage location, e.g., an internet site on which the user stored images of his/home prior to the loss for social reasons and/or as records intended to document the contents of the insured property.

In the FIG. 1 example, storage device 116 includes multiple lists of objects corresponding to different times, e.g., a pre-fire list of objects 171 corresponding to exemplary building 121 and a post damage list of objects 172 corresponding to the building 121. Each of the pre-fire list 171 and post fire lists 173 correspond to different sets of pictures with the pre-fire list 171 corresponding to images of building 121 captured during a first period of time before a fire at the building and post-fire list 173 corresponding to a second set of images of building 121 which were captured during a second period of time after a fire at building 121. Storage device 116 further includes a destroyed and/or damage list of objects 175 which lists objects which were destroyed or damaged due to the fire that occurred in the example at building 121. Destroyed/damaged objects list 175 corresponding to building 121 is generated in some embodiments by comparing lists 171 and 173 with the destroyed/damaged list including those items which are not present in post fire objects list 173 but are present in pre-fire objects list 171. Destroyed/damaged object list 175 serves in some embodiments as the basis for an automated insurance claim generated by the service provider server 102 on behalf of the owner of building 121 following a fire at the building.

Each of the lists 171 and 173, may and often do include a list of items such as furniture, books, paintings, appliances detected in each room of 123, 125, 127 of building 121 with the list 171 being a compilation or concatenation of pre-fire per room object lists generated with regard to building 121 and the list 173 being a compilation of post-fire per room object lists for building 121. Each list can and sometimes does include for each listed item manufacturer, model, purchase date, and estimated cost (e.g., purchase price) of the listed item(s) when available. Thus, in some embodiments such information is requested and obtained for detected items from the AI system or systems 97, 98, 99 used in generating the lists 171, 173. The destroyed/damaged list 175 may and sometimes does include for each listed item manufacturer, model, purchase date, and estimated cost (e.g., purchase price) of the item but in some embodiments also includes an estimate of the current value of the item provided by an AI system 97, 98, 99 which may be used in some cases for determining the amount to be covered by an insurance policy in response to a claim generated and submitted to the insurance company system 112 on behalf of the homeowner of building 121 which suffered fire damage in the present example.

When submitting an automatically generated claim the server 102 normally sends, as part of the supporting documentation, the pre and post-fire images used to generate the pre and post fire item lists 171m 173 along with lists 171, 173, 175 so that the insurance company can understand the basis of the claim and verify which items were damaged/destroyed at the home 121.

The processor 108, memory 110 and I/O interface can communicate with each other via bus 106 which connects these elements together and can communicate with other devices in the system via I/O interface and communications network 104. The communications network 104 can be the Internet with the double ended arrows shown in FIG. 1 representing communications links passing through or established using the communications network 104. Notably user device 108 is a cell phone which includes a camera while user device 111 is a personal computer which includes a scanner. Via the camera of cell phone 108 or the scanner of the computer 111 a user can upload images and/or scan/photo the text of an insurance policy or other document and submit it to the system 102 for processing and/or supporting an insurance claim.

From the above it should be appreciated that the system 100 includes a number of AI systems which can be used to support various operations.

Unfortunately, while AI systems are growing in popularity, while they have great potential, practical applications for using AI systems remain somewhat limited. This is due in part to the fact that they are relatively new and that users are unfamiliar as to how best to apply such systems to individual problems they encounter in their daily lives. Among the problems users encounter with such systems is that they often fail to understand how best to present a problem or information to the systems to obtain a useful result. In addition, given that different AI systems will often return somewhat different results, e.g., due to being trained on different data sets and/or using different models to produce a result, users are often uncertain as to whether or not they should rely on the answers returned by such systems. In many cases users may try and consult different AI systems, receive different answers and simply be left confused as to which answers to rely upon or why the answers differ.

In accordance with the invention the service provider server 102 acts as a support device which receives and processes information from a user and prompts the user to provide information and/or other input as appropriate. While the service provider system 102 uses one or more AI systems 97, 98, 99, 114 to provide service to a user of one or more of the user devices 108, 111, the user does not have to directly interact with or understand how the AI systems 97, 98, 99 or 114 work. In addition the server 102 can query the systems 97, 98, 99 when their results do not agree to obtain potential reasons why their results differ. By presenting results to the user which are consistent or by presenting differing results from multiple AI systems along with potential reasons the results differ, the service provider system 102 provides results which a user can understand and interpret while being able to consider the presented reasons the results may differ all without having to know how to directly access multiple AI systems and obtain information on reasons the results might differ. This is particularly useful when seeking advice on what causes of loss might be excluded from an insurance policy and/or limits or exceptions to the overall policy limits for particular types of losses. The system 102 can, by calls to one or more AI-systems 97, 98, 99 identify which portions of an insurance policy are relevant to a particular type of loss. In addition to such policy consideration functions, the service provider system 102 can help a user in generating supporting documentation for making a claim and/or can automatically submit a loss on a user's behalf to insurance company claims processing system 112, e.g., automatically, with supporting documentation and loss estimates generated using user input and one or more AI-systems 97, 98, 99, 114.

Having generally discussed the system 100, the steps of an exemplary method implemented in accordance with one exemplary embodiment will now be described with reference to FIG. 2. FIG. 2 is a diagram that shows how diagrams 201, 203, 205, 207, 209 and 211 of FIGS. 2A, 2B, 2C, 2D, 2E, and 2F, respectively are to be combined to form a complete flow chart.

Referring now to FIG. 2A which shows diagram 201 which is the start of the method, operation begins in start step 202 with the service provider server 102 being powered on and the main control routine 113 being executed.

The server 102 monitors for user input and in step 204 receives input from a user, e.g., user input received from user device 108 which in the example is a cell phone. The input receives a copy of an insurance policy and a question regarding overall amount of loss coverage.

To respond to the question in step 206 the server 102 sends the insurance policy text to a first AI system 97 with a question asking what are the overall coverage policy limits. The question might be and sometimes is “What are the overall coverage policy limits for the policy I provided?”. The question is presented as a natural language question since this is the type of question the first AI system 97 is designed to respond to. Operation proceeds from step 206 to step 208 where the server 102 receives the answer to the overall policy coverage limit question from the first AI system 97. With the answer from the first AI system having been received operation proceeds from step 208 to step 214.

Given that different AI systems may provide different results, and the reliability of an answer received from an AI system can be somewhat suspect, in some but not all embodiments the same question is submitted to multiple different AI systems 97, 98 and 99 and compared. The example will be explained in the case where two of the three AI systems 97, 98, 99 are used to answer a question but all three systems could be used with the results returned form the three systems being compared and possible reasons for the different answers identified.

To increase the reliability of answers provided to a user. operation proceeds from step 204 to multiple AI system inquiry steps 206, 210. In step 210 which can be performed in parallel or serially to step 206, the server 102 sends the insurance policy text to another AI system, e.g., AI system 98 with the same question, sent to the first AI system 97, asking what are the overall coverage policy limits. The question might be and sometimes is “What are the overall coverage policy limits for the policy I provided?”. The question is presented as a natural language question since this is the type of question the second AI system 98, like the first AI system 97, is designed to respond to. Operation proceeds from step 210 to step 212 where the server 102 receives the answer to the overall policy coverage limit question from the second AI system 98. With the answer from the second AI system having been received operation proceeds from step 212 to step 214.

By the time comparison step 214 is performed, an answer, e.g., overall policy coverage limits, has been received from multiple AI systems 97, 98 and in step 214 the response from the different AI systems 97, 98 is compared to determine if they agree. If the answer from the multiple AI systems agree, operation proceeds to step 222 in which the answer is communicated to the user, e.g., sent by the server 102 to the user device 108 and displayed to the user. Operation proceeds from step 222 to step 226 via connecting node A 224.

If in step 214 it is determined that the answer from the first and second AI systems did not agree, operation proceeds from step 214 to step 216. In step 216 the response from the second AI system 98 is sent to the first AI system 97 with an indication that the user making the inquiry believes the coverage policy limits returned by the second system 98 are the answer to the question and asking the first AI system why its answer is different. In some embodiments this involves the server 102 sending a follow up query to the overall coverage policy limit query indicating “I think the overall policy limits are the amount indicated by the second AI system and asking “can you suggest reasons that you came up with a different answer?”. Note that this follow up question is made without involvement by the user of the user device 108 on who's behalf the server 102 is making the query and without the user knowing this is a useful question to ask. The first AI system 97 views the follow up query as part of a natural language query and responds taking into consideration the answer previously provided to the server 102 with the system viewing the server 102 as an entity with which it interacting and with the system 97 being unaware of the end user of the user device 108 on whose behalf the server 102 is operating.

Operation proceeds from follow up query step 216 to step 218 in which the server 102 receives an explanation of likely reasons for the difference in policy limits returned by the first and second AI systems 97, 98 from the first AI system 97.

In some embodiments a similar inquiry is made of the second AI system 98 as to why its answer differs from the answer returned by the first AI system 97. However, for simplicity of illustrations reasons just the query to the first AI system 97 and response are shown in the FIG. 2B example.

With one or more possible reasons for the difference in answers having been received in step 218 operation proceeds to step 220 in which the overall policy limits retuned by the first and second systems 97, 98 are communicated to the user with the indication that they could be the amount returned by the first AI system 97 or the amount returned by the second AI system 98 with the possible reasons for the different answers that were received in step 218 also being provided to help the user of the user device 108 determine which policy limits are correct.

From step 220 operation proceeds via connecting node A 224 to step 226 shown in FIG. 2B. In step 226 input is received at the server 102 from user device 108 indicating that the user is inquiring whether a particular type of loss, e.g., loss due to wildfire, is excluded or subject to any limitations in coverage, e.g., under the provided insurance policy. In response to the inquiry from the user the server 102 sends an inquiry to the first and second AI systems in steps 228 and 232 which can be performed in parallel. In step 228 an inquiry is made to the first AI system 97 to determine if the provided policy excludes or limits coverage for the particular type of loss indicated to be of interest to the user and in step 232 the same inquiry is made by the server 102 to the second AI system 98. In steps 228 and 232 the server 102 may ask the AI systems “Are losses due to wildfire excluded or limited by the insurance policy?”. The AI systems 97 and 98 will view this question as a continuation of discussion which is ongoing with the server 102 about the submitted insurance policy. Thus, once again the server 102 acts as a proxy and uses the AI systems on behalf of the user of the user device 108 knowing about the AI systems 97, 98 and/or how to best present questions to the AI systems 97, 98.

In steps 230 and 234 the server 102 receives responses from the first and second AI systems 97, 98, respectively and then moves to determination step 236 to check if the responses from the two AI systems 97, 98 agree. If the responses from the first and second AI systems are found to agree, operation proceeds from step 236 to step 244. In step 244 the overall policy limit for losses due to wildfire indicated by the AI systems 97, 98 is communicated to the user device 108 and presented, e.g., displayed, to the user. Operation proceeds from step 244 to step 248 via connecting node C 246.

In step 236 if it is determined that the that the answers regarding whether the policy covers loss for the indicated type of loss and the maximum amount of coverage returned by the two AI systems 97m 98 do not agree, operation proceeds to step 238. In step 238 the response received form the second AI system is sent to the first AI system with an indication that you think the answer with regard to the maximum amount of coverage for the indicated loss is the amount indicated by the second AI system and asking the first AI system for reasons that its answer is different. In some embodiments this involves presenting a natural language query to the first AI system in the form “I think the policy limit for loss due to wildfire (the indicated reason for loss of interest) is Z dollars (the amount indicated by the second AI system 98) can you suggest reasons that you came up with a different answer?”. Thus, the server 102 operates as a proxy on behalf of the user of user device 108 seeking reasons why the answers returned by the first and second AI systems differ without the need for user involvement or even the user know AI systems are being consulted. In step 240 likely reasons the answers from the two AI systems 97, 98 differ in terms of the policy limit due to loss by fire are received from the first AI system 97 and then operation proceeds to step 242.

While in an inquiry regard the reasons for differences in the answer are obtained form just the first AI system 97 in the FIG. 2B example in some embodiments the second AI system is presented with the answer provided by the first AI system and asked to suggest reasons why it had a different answer. In such an embodiment by the time step 242 is reached suggested differences for the difference in answers will be available from both AI systems 97, 98 and included in the information presented to the user in step 242.

In step 242 the server 102 communicates the limits for loss due to the reasons the user inquired about, e.g., wildfire, provided by both the first and second AI systems 97, 98 along with possible reasons in the indicated coverage limit for the specified loss suggested by at least the first AI system 97 to the user device 108 where it is then presented to a user. Thus a user of device 108 can obtain information relating to policy coverage from multiple AI systems 97, 98 without having to directly interact with the systems and without even knowing how to consult or interact with such systems.

Operation proceeds from step 242 via connecting node C to step 248 shown in FIG. 2C.

In step 248, input from a user of user device 108 is received by the server 102 indicating that the user is inquiring as to what are the relevant portions of the insurance policy relating to the type of loss, e.g., wildfire loss, the user inquired about. In response to receiving the user inquiry, the server 102 sends in an inquiry to one of the AI systems, e. g,, the first AI system 97 in step 250, requesting the AI system to identify relevant portions of insurance policy relating to limits for the indicated type of loss, e.g., loss from wildfires. In some embodiments in step 250 the server 102 asks the first AI system 102 “Show me the portions of the insurance policy I provided which relate to limits on a loss due to wildfire”.

Then in step 252 the server 102 receives a response from the AI system identifying relevant portions of the insurance agreement. The server 102 can and sometimes does also request the second AI system 98 to identify relevant portions of the policy relating to wildfire loss and will receive a response from that system as well.

In step 254 the server 102 communicates to the user device 108 the relevant portions of the insurance policy relating to wildfire loss identified by the first and/or second AI systems 97, 98 and the user device 108 then displays the identified portions of the insurance policy to the user.

With the user having been made aware of the limits and coverage provided by the insurance policy thanks to the server 102 acting as a proxy for the user and consulting one but in many cases multiple AI systems 97, 98, operation proceeds from step 254 to step 256 in which the server 102 communicates to the user device 108 an offer of assistance in documenting the loss and submitting a claim for loss, e.g., loss of a building and its contents due to wildfire. The offer of assistance is presented to the

In step 258 the server 102 determines if the user requested assistance with regard to documenting property, e.g., a building 121 and its contents, and/or making a claim for a loss, e.g., destruction of the building 121 or portions of the building 121 due to a fire. If the user declined the offer of assistance operation proceeds from step 258 to stop step 260 in which the server 102 stops providing assistance to the user of user device 108 but will respond is the user sends the server 102 a new request for assistance.

If in step 258 it is determined that the user requested assistance with regard to documenting property and/or making a claim for a loss operation proceeds from step 258 to step 261 in which a check is made to determine if a pre-damage list 171 of objects corresponding to the building 121 or property of interest already exists, e.g., due to previous use of the system to document the contents of the building 121 by generating the list 171 and storing it in the service provider server 102 in the event of a future loss due to damage, e.g., due to a wildfire. If the pre-damage list of objects corresponding to the building 121 corresponding to the user of the system already exists, steps related to generated the list 171 are skipped and the process proceeds from step 261 to step 310 of FIG. 2F. However, if the pre-damage list of objects corresponding to the building 121 corresponding to the user does not already exist, operation proceeds from step 261, via connecting node D 262, to step 264 in FIG. 2D so that the insured property, e.g., building 121, and its contents can be documented in the event an insurance claim needs to be generated in the future, e.g., due to damage from a fire.

In step 264 the sever 102 sends a request to the user device 108 requesting that the user provide information on the number of rooms in the building for which they want to document a claim and the type of each room. This request is displayed by the user device 108 to the user and in step 266, the server 102 receives input from the user, communicated by the user device 108 to the server 102, indicating the number of rooms and type of reach room in the building for which a claim is being made. In the FIG. 2D example the user indicates the building, a house includes a total of 6 rooms that include 1) a kitchen, 2) a bathroom, 3) a living room, 4) a first bedroom, 5) a second bedroom and 6) an office.

With the room information having been received by the server 102 in step 266 operation proceeds to step 268 in which the server assigns a room identifier, e.g., number and/or label to each room. In the example the number 1 is assigned to the kitchen and the label “kitchen” is also assigned to the room to help in identifying the room to the user. The second room is assigned the number 2 and the label bathroom. The third room is assigned number 3 as an identifier and the label living room. The fourth room is assigned the number identifier 4 and the word label “first bedroom”. The fifth room is assigned room identifier number 5 and the word label “second bedroom”. The sixth room is assigned room identifier number 6 and word label “office”. With numeric and word label identifiers having been assigned to the rooms in step 268 operation proceeds to step 270.

In step 270 the server 102 sends a request to the user device 108 requesting the user upload or provide access to one or more pictures corresponding to each identified room. The user device 108 displays the request to the user then uploads the requested room pictures to the server 102 which receives and stores them in step 272.

Operation proceeds from step 272 to step 274 which represents the start of a per room inventory generation step which includes steps 274 to 304 which are performed for each room until in step 304 it is determined that inventory and cost estimates have been generated for each room identified by the user.

In step 274 the picture or pictures corresponding to a room, e.g., the room for which an inventory is being generated, are sent to one of the AI systems 77 or 78 and/or image recognition system 114 with a request that a list of furniture items visible in the picture or pictures corresponding to the room be generated. For purposes of explaining the process it will be assumed that AI system 97 is used for identifying items in a room and generating the itemized inventory. During the first loop of step 274 the image or images corresponding to the first room will be provided to the AI or image recognition system for processing while during the next iteration the images corresponding to the second room will be provided, and so on until an inventory is generated for each of the rooms.

Operation proceeds from step 274 to step 275 in which the server 102 receives a list of furniture from the AI system 97. Then in step 276 the server 102 asks the first AI system 97 to determine the brand of each furniture item in the list. In step 277 the server 102 receives furniture item brand information from the first AI system 97. Then in step 278 the server 102 asks the first AI system 97 to determine the cost of each identified item of furniture, e.g., taking the brand information into consideration.

Then in step 279 the server 102 receives the requested cost information from the first AI system 97 and proceeds in step 280 to created an itemized furniture list including manufacturer and cost information for the room to which the image(s) being processed relate.

Since furniture is only a portion of a rooms contents, the server 102 proceeds to use the first AI system 97 to identify, itemize, count and estimate the cost of other items in the room to generate as complete an inventory and cost estimate for the room as possible from the available information.

Operation proceeds from furniture list step 280 to step 282 in which the server 102 requests the AI system 97 to identify other items in the room such as books, pens, lamps, art work and appliances. This request may be made as a single request or a number of sequential individual requests with the server presenting the requests in a manner that is easy for the AI system 97 to respond to.

In step 283 the server 102 receives a response to the request to identify additional items. Then in step 284 the server 102 asks the first AI system 97 to create a list of any other items in the room it has not already identified and provide a count of each identified item. This request is made in the event the AI system 97 did not fully search or identify items due to the wording of one or the previous requests.

Operation proceeds from step 284 to step 288 of FIG. 2E via connecting node E 286. In step 288 the server 102 asks the AI system to estimate the cost of each item, e.g., non-furniture item on the list of identified items or additional items it returned in response to a previous item identification request.

In step 289 the server receives item cost information from the first AI system 97 for the identified items and uses this to complete an inventory of times in the room along with available cost information provided by the first AI system 97.

In order to allow a user to review, comment and update the automatically generated inventory and cost information for the room, operation proceeds from step 289 to step 290 in which the generated itemized inventory and cost information for the room is communicated from the server 102 to the user device 108 and displayed to the user. In some embodiments, the communicated inventory information includes manufacture information when available for an item. Then in step 292 the server 102 sends in inquiry to the user device 108 asking if the user would like to supplement information relating to the listed items by providing manufacture, model number and/or other information about a listed item on the provided room inventory list.

In step 293 the server 102 receives from the suer device 108 user input providing model number and/or other information for one or more items on the room inventory.

Then in step 294 the server 102 updates the list, e.g., room inventory, with manufacturer, model number and/or other information provided by the user for items on the inventory list. Thus the list may now include manufacturer and/or model numbers of items on the list which the AI system 97 was unable to automatically provide.

With item information having been updated based on user input, operation proceeds to step 296 in which the server 102 requests that the first AI system 97 provide updated item cost information based on the updated information provided by the user.

Then in step 297 the server 102 receives updated cost information from the first AI system 97 and updates the itemized room inventory based on the received information. Next in step 208 the server 102 provides the user the opportunity to add additional items to the room inventory that were not automatically identified along with any manufacturer, model or cost information that the user might have for the items being added to the inventory.

Then in step 299 the server updates the room inventory based on information provided by the user and received from the user device 108 which communicates the user provided information to the server 102. Operation proceeds from step 299 to step 300 in which the server 102 requests the first AI system 97 to provide cost estimates for any items added to the list by the user for which cost information was not provided. Then in step 301 a response is received and the cost information is added to the room inventory. Then in step 302 the generated itemized room inventory which is now complete with a full list of furniture, appliances, and other items along with manufacturer and/or model information along with a cost for each item is formatted and stored, e.g., for use in making a claim for loss.

With the itemized room inventory for one of the rooms having been generated and stored in step 302 operation proceeds to step 304 to check if an inventory including cost estimates have been generated for each room of the building, e.g., all 6 rooms in the example. IF in step 304 it is determined that an inventory has not been generated for all the rooms, operation proceeds via connecting node F 306 to step 274 so that the room inventory generation process can be performed for the next list of rooms in the list of rooms corresponding to the building until an inventory has been generated for all the rooms.

In step 304 if it is determined that an inventory and cost estimate has been generated for each of the rooms in the building operation proceeds via connecting node G 308 to step 310 shown in FIG. 2F in which the server 102 asks the user, e.g., by sending a message to user device 108 which is displayed to the user, if the user would like to automatically submit a claim for loss based on the generated detailed room inventory.

In step 312 a response is received by the server 102 from the user device 108. Then in step 312 a determination is made by the server 102 if the user indicated a desire to submit a claim. If the user indicated that they did not want to submit a claim operation proceeds to stop step 320 with the generated inventory stored and available for use should the user decide to submit a claim at some future time.

If however, in step 312 the server 102 determines that the user wants to submit an insurance claim operation proceeds to step 314 in which the server 102 sends a request to the user device 108 requesting that the user upload post-damage pictures of the building for which a claim is to be made, e.g., pictures showing fire or other damage which resulted in destruction of one or more rooms and/or damage to rooms. Operation proceeds from step 314 to step 316 in which the user provided post-damage pictures showing the loss are received at the server 102, e.g., from the user device 108 which in many cases includes a camera used to capture pre and/or post-damage pictures of the exterior and/or rooms of building 121 which are communicated to the server 102 via communications network 104. Operation proceeds from step 316 to step 400 in which the server 102 determines the amount of damage to the building 121 and/or items included therein. In various embodiments step 400 includes one or both of steps 402 and 404. In step 402 building damage, e.g., which rooms were destroyed or damaged, is determined from user provided pictures, e.g., pictures provided by the user of the building prior to the damage and subsequent to the damage. Depending on the extent of fire all rooms of the building may have been destroyed with the building having been burnt to the ground. However in other cases the comparison of pre-damage and post damage images may reveal that only a portion of the building was burnt down in which case the destroyed and/or rooms are determined in step 402. Destroyed will generally be used to refer to rooms which have been total burnt and the contents of the room fully destroyed while damaged rooms may refer to a room which was not totally destroyed. As part of step 400, in some cases a user provides input indicated the rooms of the building which were damaged or destroyed and the information is received in step 404. The server 102 stores information indicating which rooms of the building 121 were destroyed and which rooms, if any were damaged, e.g., by a fire or other damage event. If the building 121 is burnt to the ground all rooms in the building will be indicated to have been destroyed. The damaged/destroyed room information is stored in storage device 116 for future use as needed.

With building damage having been determined in step 400 operation proceeds to step 406. In step 406 a check is made as to whether the user indicated a desire to submit a claim for compensation for the damage, e.g., an insurance claim. If the user did not indicate a desire to submit a claim operation process to stop step 408 since further processing regarding building 121 is not required but the images of the damaged building 121 and list of damaged/destroyed rooms is preserved to document the loss and support an insurance claim in the future if desired.

If in step 406 it is determined that the user wants the server 102 to generate and submit an insurance claim, e.g., automatically based on the received pictures and information relating to building 121, operation proceeds from step 406 to step 410. In step 410 the server 102 accesses the stored list 171 of times in the building 121 for which the insurance claim is to be generated, with the list including building, rooms and room content information (e.g., items such as furniture, TV, sinks, countertops, paintings, etc. and corresponding manufacturer and model number information on a per item basis) relating to the building 121 and its room contents prior to the damage.

Operation proceeds from step 410 to step 415 which is a generated destroyed items lists which results in generation of list 175. The generate destroyed items list includes multiple steps and starts with step 416 shown in FIG. 2G via connecting nodes 412 H.

For a destroyed room the server 102 can rely on the fact that when the room was destroyed, e.g., total burnt down, the objects known to be in the room were destroyed when the room was destroyed. In step 416 for each destroyed room the server 102 identifies the items that were in the room prior to the rooms destruction, e.g., by accessing the room content list for each destroyed room included in the pre-fire room object list of the pre-damage list 171 for building 121. The items that were in the destroyed rooms of the building 121 are added in step 418 to a destroyed items list corresponding to building 121 that is being generated by the server 102 for purposes of automatically generating an insurance claim that can be submitted electronically.

With the objects that were in the destroyed rooms having been added to the destroyed items list for the damaged (which can include full destruction in the case where the building burns to the ground) building 121 operation proceeds to step 420.

In step 420 a check is made to determine if there are any rooms in the building which were damaged but not destroyed which may be the case where a fire or other event only partially destroys a building while leaving some of the building's rooms intact and/or damaged. The determination made in step 420 is based in some embodiments on one or more images of the building 121 post damage and whether the images show any damaged rooms which were not fully destroyed.

If in step 420 the server 102 determines that there are no rooms that were damaged but not destroyed, operation proceeds from step 420 to step 442 of FIG. 2H via connecting node 440.

However, if in step 420 it is determined that there are one or more rooms of the building 121 of interest which were damaged but not destroyed, operation proceeds from step 420 to step 422 so that a check can be made as to what items might have survived (e.g., in good condition) the damage to the building 121 and thus should not be included in the destroyed items list and what items that were present before the damage incident that are not visible and/or are damaged in the damaged rooms should and will be included in the destroyed items list.

One way of generating a list of destroyed items that is used in some embodiments is identification of items in one or more damaged rooms, e.g., using AI, comparison of the items in the damaged rooms to the content before the damage, and including in the destroyed items list the items no longer present following the damage.

In step 422 the post damage images of damaged rooms are sent by the server 102 to an AI system 97, 98, 99 or 114 for analysis. Then in step 424 the server 102 asks the AI system 97, 98, 99 or 114 to identify items in damaged rooms, i.e., items in the damaged rooms that are in good condition and thus should not be included in a damaged or destroyed items list.

Operation proceeds from step 424 to step 426 in which a post damage list of items, e.g., present in one or more damaged rooms is received form the AI system to which the post damage images were sent. The list can and sometimes does include items on a per-room basis making a comparison to the items determined to be in the room pre-damage to the items in the room post-damage easy and straight forward.

With the post-damage list of items found to be present in one or more damaged rooms, e.g., with the items listed on a per room basis, having been received in step 426 operation proceeds to step 428 where the received list or lists of items present in damaged rooms are used, e.g., combined, to generate a post damage list of times in damaged rooms indicating the total set of items identified in the damaged rooms of the damaged building 121. The overall list of items detected in the damaged rooms can be, and sometime is, combined with items in the pre-damage list 171 which were known to be in undamaged rooms to form an overall post damage list 173 of objects in the damaged building 173 with the items being itemized on a per room basis in some embodiments so that the per room contents can be understood and used as needed.

With the post-damage list of items present in damaged rooms having been generated, operation process from step 428 to step 430. In step 430 pre-damage room content information included in pre-damage list 171 is compared to post-damage room content information to identify destroyed items which are no longer present and assumed to be missing due to the damage, e.g., fire to building 121. Operation proceeds from step 430 to step 432 in which items determined to have been destroyed, e.g., items which were present prior to the damage but not present (or are seriously damaged indicating item destruction) after the damage incident, e.g., fire, are included in the destroyed items list 175.

With the destroyed items list 175 having been generated by the end of step 432 and including the contents of destroyed rooms as well as destroyed items corresponding to damaged rooms of the building 121, operation proceeds to step 434 in which the server 102 sends the destroyed items list to the user device 108 so that the user can comment, supplement, add to or correct the information, e.g., list of items including in the destroyed items list. For example, the user can and sometimes does add a destroyed item to the list which was not included in the destroyed items list and/or remove a destroyed item from the list which the user knows was not present at the time of the damage incident.

Operation proceeds from step 434 to step 436 in which the server 102 receives user input approving the damaged items list that was automatically generated, adding one or more items to the damaged items list and/or removing one or more items from the damaged items list. Then in step 438 the server 102 update the destroyed items list 175 to reflect the changes the user indicated should be made to the destroyed items list 175.

With the destroyed items list 175 having been completed and including items that were known to be in completely destroyed rooms and items which are missing from damaged but not fully destroyed rooms, operation proceeds from step 438 via connecting node I 440 to step 442 of FIG. 2H which shows a portion 215 of the overall flow chart 200.

In step 442 the server 102 automatically sends an insurance policy relating to the insured building 121 to an AI system 97, 98, or 99 for review by the AI system. Then in step 102 the server 102 sends a query to the AI system asking if the insurance policy corresponding to the building 121 provides for payment for destroyed items in an amount corresponding to a replacement cost of the destroyed times or the actual value of the destroyed items goods which is often lower than the replacement cost. This allows for the server 102 to determine what type of cost information should be included in an insurance claim without requesting the user to provide such information. In step 447 the AI system responds and in 448 evaluation takes into consideration the type of coverage provided for destroyed items.

If in step 448 it is determined that the insurance policy provides for destroyed item replacement cost operation proceeds from step 448 to step 450 in which the list of destroyed items 175 is sent to the AI system 97, 98, and/or 99 and then in step 452 the AI system to which the list of destroyed items is sent is asked to provide replacement costs for each of the items in the destroyed items list 175. Operation proceeds from step 452 to step 458.

If in step 448 it is determined that the insurance policy does not provide for destroyed item replacement cost, and thus instead provides for payment for the current value of the destroyed items, operation proceeds from step 448 to step 454 in which the list of destroyed items 175 is sent to the AI system 97, 98, and/or 99 and then in step 456 the AI system to which the list of destroyed items is sent is asked to provide the current value of each of the items in the destroyed items list 175. Operation proceeds from step 456 to step 458.

In step 458 the AI system returns replacement cost and/or current value of destroyed items information on a per item basis. The type of information returned will match the type of coverage provided for in the insurance policy, e.g., replacement cost or current value, for each destroyed item this information is added to the destroyed items list so that the list includes for each listed item, in addition to manufacture and model number (when available), the value associated with the item thus indicating the amount of compensation being sought for the destroyed item.

Operation proceeds from step 458 to step 460 in which an insurance claim is automatically generated by server 102 based on the information generated with regard to destroyed and/or damaged items in the building 121 and the estimated replacement cost or current value of the individual destroyed items. The insurance claim is automatically generated by the server 102 on behalf of the user with the insurance coverage on the damaged or destroyed building 121 and on who's behalf the server 102 is generating the claim. Thus in step 460 an insurance claim in the form of an electronic request for compensation is generated with the claim including, in some embodiments, an insurance policy identifier, e.g., number, requested compensation information indicating the amount of compensation (e.g., determined replacement cost or value) being requested for each destroyed item in the building 121 as well as for damage to the building 121 itself in some embodiments, a list of destroyed items. In support of the claim the claim maybe and sometimes include and/or is submitted with the list 175 of destroyed and/or damaged items and the pre-damage list of items in the building 171. Supporting pre-damage images used to generate the list 171 and post damage images used to generate the list 175 are also included with item manufacturer and model number for many of the items. Thus the claim for compensation for damage to the building 121 is well supported by photographic evidence as well as the value information generated by one or more AI systems and presented in an itemized electronic form which can be easily processed and checked on a pre-room and/or per item basis.

With the electronic insurance claim having been generated in step 460 by the server 102 operation proceeds to step 462 in which the server 102 automatically submits the claim for coverage and damage compensation by sending it electronically to the insurance company claims processing system 112 via communications network 104. The claim is also sent to the user device 108 in some embodiments in step 462 so that the user has a copy of the claim and is aware of the submission.

By using the server 102 and user device 108 a user can generate and submit an electronic claim for damage to a building 121 or other structure with clear documentation and estimates of the amount for which compensation should be paid for destroyed items. The processing of images, e.g., pictures, provided to the server 102, either before and/or after damage to the building 121 which can be captured and provided directly from user device 108, allows a user to easily document and submit claims even when forced to relocate away from the damaged or destroyed building and without the need for sophisticated devices or even a personal computer.

Thus it should be appreciated that the method of the invention allows for addressing technical issues with respect to documents the contents of a building itself, documenting damage to the building, generating itemized documentation of destroyed items, automatically generating an electronic claim and submission of such a claim to an insurance company system 112 even when being forced to relocate to a new location due to building destruction/damage.

With the claim having been submitted electronically in step 462, operation of the server 102 proceeds via connection node J 464 back to stop step 408 until the process 200 is restarted to provide service with regard to another insurance policy and/or generate and submit a new claim.

FIG. 2 is a diagram 200 showing how the diagrams of FIG. 2A 201, FIG. 2B 203, FIG. 2C 205, FIG. 2D 207, FIG. 2E 209, FIG. 2F 211, FIG. 2G 213 and FIG. 2H 215 are to be combined to form a complete flow chart showing the steps implemented in an exemplary embodiment.

While the room inventory generation process and damage documentation process has been described in the context of preparing an insurance damage claim submission, in some embodiments the room inventory is generated before any loss based on user provided pictures as a method of documenting and recording a buildings contents in the event of a future unexpected loss. In such a case the pre-damage list 171 is generated prior to any damage or fire and stored in the service provider system 102. Thus, it should be appreciated that in some embodiments a user can contact the server and request building and/or room inventory generation without first submitting insurance policy questions or even a copy of an insurance policy. In such cases the user is immediately sent to step 264 so that the server can generate the desired itemized room/building inventory without first dealing with any specific policy related issues.

In other embodiments the pre-damage list 171 and post damage list 173 are generated from pre-damage pictures and post damage pictures, respectively with the generation of the lists 171, 173 being performed after a damage event, e.g., when a user is seeking to generate and submit an insurance claim.

The techniques of various embodiments may be implemented using software, hardware and/or a combination of software and hardware. Various embodiments are directed to apparatus, e.g., base stations, access points, user equipment (UE) devices, core network devices, etc. Various embodiments are also directed to methods, e.g., method of controlling and/or operating base stations, UEs such as smartphones, desktop computers, portable computers, and/or other devices with wireless capability, and core network devices.

Various embodiments are also directed to a machine, e.g., computer, readable medium, e.g., ROM, RAM, CDs, hard discs, etc., which include machine readable instructions for controlling a machine to implement one or more steps of a method, e.g., any one of the methods described herein. The computer readable medium is, e.g., non-transitory computer readable medium. It is understood that the specific order or hierarchy of steps in the processes and methods disclosed is an example of exemplary approaches. Based upon design preferences, it is understood that the specific order or hierarchy of steps in the processes and methods may be rearranged while remaining within the scope of the present disclosure. The accompanying method claims present the various steps in a sample order and are not meant to be limited to the specific order or hierarchy presented. In some embodiments, one or more processors are used to carry out one or more steps of each of the described methods.

In various embodiments each of the steps or elements of a method are implemented using one or more processors. In some embodiments, each of elements or steps are implemented using hardware circuitry.

In various embodiments devices, e.g., base stations, access points, UEs, and/or core network devices that are described herein are implemented using one or more components to perform the steps corresponding to one or more methods. Thus, in some embodiments various features are implemented using components or in some embodiments logic such as for example, logic circuits. Such components may be implemented using software, hardware or a combination of software and hardware. Many of the above described methods or method steps can be implemented using machine executable instructions, such as software, included in a machine readable medium such as a memory device, e.g., RAM, floppy disk, etc. to control a machine, e.g., general purpose computer with or without additional hardware, to implement all or portions of the above described methods, e.g., in one or more devices, servers, nodes and/or elements.

Accordingly, among other things, various embodiments are directed to a machine-readable medium, e.g., a non-transitory computer readable medium, including machine executable instructions for causing a machine, e.g., processor and associated hardware, to perform one or more of the steps of the above-described method(s). Some embodiments are directed to a device, e.g., a controller, including a processor configured to implement one, multiple or all of the steps of one or more methods of the invention.

In some embodiments, the processor or processors, e.g., CPUs, of one or more devices, e.g., user (UE) devices such as cell phones, base stations, access points, core network devices include a processor configured to control the device to perform steps in accordance with one of the methods described herein. The configuration of the processor may be, and sometimes is, achieved by using one or more components, e.g., software components, to control processor configuration and/or by including hardware in the processor, e.g., hardware components, to perform the recited steps and/or control processor configuration.

Some embodiments are directed to a computer program product comprising a computer-readable medium, e.g., a non-transitory computer-readable medium, comprising code for causing a computer, or multiple computers, to implement various functions, steps, acts and/or operations, e.g., one or more steps described above.

Depending on the embodiment, the computer program product can, and sometimes does, include different code for each step to be performed. Thus, the computer program product may, and sometimes does, include code for each individual step of a method, e.g., a method of controlling a controller or node. The code may be in the form of machine, e.g., computer, executable instructions stored on a computer-readable medium, e.g., a non-transitory computer-readable medium, such as a RAM (Random Access Memory), ROM (Read Only Memory) or other type of storage device. In addition to being directed to a computer program product, some embodiments are directed to a processor configured to implement one or more of the various functions, steps, acts and/or operations of one or more methods described above. Accordingly, some embodiments are directed to a processor, e.g., CPU, configured to implement some or all of the steps of the methods described herein. The processor may be for use in a base station, an AP, a UE, a mobile communications system, and/or a core network, for example, but could be in other devices as well. In some embodiments, components are implemented as hardware devices in such embodiments the components are hardware components. In other embodiments components may be implemented as software, e.g., a set of processor or computer executable instructions. Depending on the embodiment the components may be all hardware components, all software components, a combination of hardware and/or software or in some embodiments some components are hardware components while other components are software components.

Numerous additional variations on the methods and apparatus of the various embodiments described above will be apparent to those skilled in the art in view of the above description. Such variations are to be considered within the scope. Numerous additional embodiments, within the scope of the present invention, will be apparent to those of ordinary skill in the art in view of the above description and the claims which follow. Such variations are to be considered within the scope of the invention.

What is claimed is:

1. A method of generating and using building content information, the method comprising:
operating a server (102) to receive (270) a first picture of a first room (123) of a building (121), said first picture corresponding to a first period of time (e.g., a period prior to a fire or other disaster damaging building 121);
operating the server (102) to send (274) the first picture of a first room (123) to a recognition system (97, 98, 99 or 114) for room content identification; and
receiving (275) from the recognition system (97, 98, 99 or 114) information indicating objects in the first room; and
storing (302) a first list of objects (171) including the objects in one or more rooms (e.g., a list of objects 171 returned by the recognition system (97, 98, 99 or 114) listing the content of one or more rooms, e.g., furniture and/or other objects in the rooms (123), (125), (127) prior to damage from, e.g., a fire).

2. The method of claim 1,
wherein the object recognition system is a first large language model (LLM) AI system (97, 98, or 99) and
wherein the first list of objects is part of a room inventory listing furniture and other objects in the first room.

3. The method of claim 2,
wherein the first list of objects (171) includes multiple items of furniture.

4. The method of claim 3, further comprising:
operating the server (102) to request (276) from the recognition system (97, 98, 99 or 114) brand information for furniture included in the first list of objects (171).

5. The method of claim 4, further comprising:
including (performed as part of step 302) in the first list of objects, for at least one object in the list, i) brand information, ii) model information, or iii) both brand and model information.

6. The method of claim 6, further comprising:
operating the server (102) to request (276) from the recognition system (97, 98, 99 or 114) cost information for furniture included in the first list of objects.

7. The method of claim 6, further comprising:
operating the server (102) to receive (316) a post-damage picture of the building (121);
operating the server (102) to determine (400) building damage including identifying (402) one or more rooms of the building which were damaged or destroyed by a damage event (e.g., fire) (e.g., by identifying portions of the building which are missing by comparing a the post damage picture to a pre-damage picture or by detecting that all or portions of the building are missing in the post-damage picture).

8. The method of claim 7, further comprising:
operating the server (102) to generate (415) (steps 416 through 438 of FIG. 2G) a list (175) of destroyed (and/or damaged) items (175) at the building (121) (e.g., due to the damage event such as a wildfire, storm or other event for which an insurance claim may be made).

9. The method of claim 8, wherein generating the list (175) of destroyed items includes:
identifying (416) items in a destroyed room of the building (e.g., which were destroyed by the damage event) based on items which are listed as being in the destroyed room in the pre-damage list (171).

10. The method of claim 9, further comprising:
operating the server (102) to request (452) from an AI system (97, 98, or 99) replacement cost for items destroyed or damaged by the damage event.

11. The method of claim 9, further comprising:
operating the server (102) to provide (442) a copy of an insurance policy corresponding to the damaged building (121) to an AI-system and request the AI system;
operating the server (102) to request (446) from the AI-system whether the insurance policy provides for replacement cost or current value being paid for destroyed items; and
operating the server (102) to receive (447) from the AI-system (97, 98 or 99) information indicating whether the insurance policy provides for replacement cost or current value being paid for destroyed items.

12. The method of claim 11, further comprising:
in response to the server (102) receiving an indication that the insurance policy provides for replacement cost of destroyed items, operating the server (102) to request (452) from an AI system (97, 98, 99) a replacement cost for items destroyed or damaged by the damage event.

13. The method of claim 12, further comprising:
in response to the server (102) receiving an indication that the insurance policy provides for current value being paid for destroyed items, operating the server (102) to request (456) from an AI system (97, 98, 99) a current value for items destroyed by the damage event.

14. The method of claim 10, further comprising:
operating the server (102) to generate (460) an insurance claim relating to the building on behalf of a user; and
operating the server (102) to automatically communicate (462) the generated insurance claim in electronic form to an insurance company claims processing system (112).

15. The method of claim 14, further comprising:
providing with the insurance claim one or more pre-damage pictures corresponding to the building (121) along with one or more post-damage pictures corresponding to the building.

16. The method of claim 15, wherein
operating the server (102) to generate the insurance claim relating to the building on behalf of a user includes:
including in the insurance claim said list of destroyed items (175) and corresponding cost information indicating a replacement cost or current value of destroyed items included in the list of destroyed items (175).

17. A server including:
an interface (104); a
storage device (116); and
a processor configured to control the server to:
receive (270) a first picture of a first room (123) of a building (121), said first picture corresponding to a first period of time (e.g., a period prior to a fire or other disaster damaging building 121);
send (274) the first picture of a first room (123) to a recognition system (97, 98, 99 or 114) for room content identification; and
receive (275) from the recognition system (97, 98, 99 or 114) information indicating objects in the first room; and
storing (302) a first list of objects (171) including the objects in one or more rooms (e.g., a list of objects 171 returned by the recognition system (97, 98, 99 or 114) listing the content of one or more rooms, e.g., furniture and/or other objects in the rooms (123), (125), (127) prior to damage from, e.g., a fire).
